(19) United States
(12) Patent Application Publication
(10) Pub. No.: US 2008/0166521 A1
(43) Pub. Date: Jul. 10, 2008

(54) SELF-CONTAINED MAT ASSEMBLY

(75) Inventor: Ronald N. Kessler, Girard, OH (US)

Correspondence Address: SAND & SEBOLT, AEGIS TOWER, SUITE 1100, 4940 MUNSON STREET, NW, CANTON, OH, 44718-3615, US

(73) Assignee: R&L MARKETING & SALES, INC., Boardman, OH (US)

(21) Appl. No.: 11/945,758

(22) Filed: Nov. 27, 2007

Related U.S. Application Data
(60) Provisional application No. 60/878,875, filed on Jan. 5, 2007.

(51) Int. Cl. B32B 3/10

(52) U.S. Cl. 428/137

(57) ABSTRACT

A self-contained floor mat assembly that comprises a tray with a flow-through mat insert positioned thereon. The tray has an upper surface and a lower surface and the lower surface rests on the floor. The flow-through mat insert is positioned on the upper surface of the tray and the insert includes at least one hole that extends from the upper surface thereof through to a lower surface thereof. When people walk across the mat, liquid and particulate matter is scraped from their shoes and drops through the holes in the insert and onto the upper surface of the tray. If the insert is not secured to the tray, it may be periodically removed from the tray for cleaning purposes. The self-contained mat assembly can be moved and positioned anywhere on the floor surface as desired.

### CROSS REFERENCE TO RELATED APPLICATIONS

This application claims priority from U.S. Provisional Application Ser. No. 60/878,875 filed Jan. 5, 2007; the disclosure of which is incorporated herein by reference.

### BACKGROUND OF THE INVENTION

1. Technical Field

This invention generally relates to floor mats. More particularly, the invention relates to a movable entryway mat assembly for a building. Specifically, the invention relates to a floor mat assembly that comprises a flow-through mat insert that is removably received within a recess in an impermeable tray.

2. Background Information

Floor mats are frequently positioned in the entryway to buildings so that customers and visitors entering the building can wipe off their shoes and thereby reduce the amount of particulate matter, water or snow tracked into the building. There are a number of currently known floor mats that are used for this purpose. Each of the currently known mats is designed to serve a slightly different function. So, for example, some mats are made with an absorbent uppermost layer that wicks water away from the upper surface of the mat so that as a customer walk across the same, their shoes are effectively dried. Yet other mats are made from a fibrous material that scrapes matter from the underside of the customers' shoes. The particulate matter and water droplets fall between the fibers and become trapped therein and this reduces the matter tracked into the building. Yet other mats are of a flow-through type construction and include a plurality of grid-like ribs that remove the particulate and liquid matter from shoes crossing over the same. These mats are typically installed into a recessed area in the floor at the entryway to the building. The recessed area acts as a trap to prevent water and particulate matter from creeping out from under the mat and creating a slipping hazard on the floor surface surrounding the mat. This type of mat system is usually cleaned with a vacuum cleaner being passed over the flow-through mat to suck up dirt that has fallen into the recess. Such a mat system is disclosed in U.S. Pat. No. 5,882,764, that shows a flow-through type mat secured by a clip into a recessed area in the floor.

It is not always possible to provide such a fixed, recessed mat system wherever a floor mat is needed. This problem has been previously addressed in the prior art, such as in U.S. Pat. No. 4,415,620 issued to Yamazaki et al. Yamazaki discloses a rubber base plate into which a carpet type of door mat can be placed. The base plate and fibrous mat can then be positioned in the desired location. The base plate includes a plurality of inwardly-directed, stepped areas so that if the carpet shrinks after cleaning, then the gap between the carpet and the side regions of the base plate will not be immediately apparent.

U.S. Pat. No. 4,143,194 issued to Wihksne discloses a movable “tacky mat” type floor mat system that is designed for use in places such as hospitals or laboratories. The mat system includes a disposable support base with a plurality of successively peelable tacky sheets mounted thereon. As people walk over the top sheet, an adhesive causes loose particulate matter to adhere to the sheet. When the sheet is essentially no longer tacky because of the presence of so much dirt on its surface, it is peeled from the stack and is thrown away. When all of the sheets on the support have been thrown away, the support is no longer of use and it is also disposed of. The support base may include beveled regions that are provided on at least two sides of the stack of tacky sheets. Initially, the depth of the stack of sheets approximates the height of the beveled regions on the support base. However, as the sheets are disposed of, the stack becomes reduced in thickness and the beveled surfaces themselves may become a tripping hazard. The support typically is manufactured from an inexpensive plastic material and may need to have an adhesive tape or some other frictional material on its underside to stop it from sliding across the floor surface.

European Patent No. 0 359 478 issued to Stamatiuo et al also discloses a mat holder that is designed to receive and retain very thin, flexible disposable sheets within it. The sheets used in association with the disclosed mat holder are only a few millimeters thick and are prone to wrinkle and slip. Consequently, the holder has to include some means for retaining a sheet firmly and preventing it from wrinkling and bunching up as people walk across the holder. The patent discloses a variety of gripping means provided on the holder for retaining the sheets therein. One of these gripping means is a lip that extends outwardly away from the walls of the base and forms a thin, elongated channel that retains the outer edges of the sheet. The channels are designed to tightly receive the outer edges of the sheet and consequently the channel is also only a few millimeters thick. The channel also has to be fairly deep so that a sufficient area of the sheet is contacted by the lip. As a result of this, the lip extends inwardly from the wall of the base for some distance. The lip is also provided with slits at each interior corner thereof so that individual sections of the lip can be raised to insert the outer edge of the sheet. When a sheet is removed from the holder, it can easily be slid out of the channels because of its thin and flexible nature. Consequently, the sheet exerts little force on the lips during either insertion or removal of the same.

In some applications, such as the entryway to a large shopping mall, the quantity of liquid or particulate matter that might be deposited on an entryway mat is too large for any of the previously described mat systems. However, it may not be possible to provide recessed areas in the floor for the insertion of flow-through type mats and simply placing such mats on the floor surface might prove hazardous. There is therefore a need in the art for a mat system that can be moved from one location to another as needed, can be used in high traffic areas and can quickly and easily be installed, removed and cleaned

### SUMMARY OF THE INVENTION

The device of the present invention is a self-contained floor mat assembly that comprises a tray with a flow-through mat insert positioned thereon. The tray has an upper surface and a lower surface and the lower surface rests on the floor. The flow-through mat insert is positioned on the upper surface of the tray and the insert includes at least one hole that extends from the upper surface thereof through to a lower surface thereof. When people walk across the mat, liquid and particulate matter is scraped from their shoes and drops through the holes in the insert and onto the upper surface of the tray. If the insert is not secured to the tray, it may be periodically removed from the tray for cleaning purposes. The self-contained mat assembly can be moved and positioned anywhere on the floor surface as desired.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is an exploded perspective view of a first embodiment of a mat assembly in accordance with the present invention;

FIG. 2 is a top view of the mat assembly of FIG. 1;

FIG. 3 is a cross-sectional front view of the mat assembly through line 3-3 of FIG. 2; showing the mat insert resting on the upper surface of the base;

FIG. 4 is a cross-sectional front view of a second embodiment of a mat assembly in accordance with the present invention and showing the mat insert secured to the upper surface of the base;

FIG. 5 is an exploded perspective view of a third embodiment of a mat assembly in accordance with the present invention;

FIG. 6 is a top view of the mat assembly of FIG. 5;

FIG. 7 is an exploded perspective view of a fourth embodiment of a mat assembly in accordance with the present invention;

FIG. 8 is a top view of the mat assembly of FIG. 7;

FIG. 9 is a cross-sectional front view of the mat assembly through line 9-9 of FIG. 8;

FIG. 10 is a cross-sectional side view of a fifth embodiment of a mat assembly in accordance with the present invention showing the base and side wall portion of the tray formed as an integral piece.

### DETAILED DESCRIPTION OF THE INVENTION

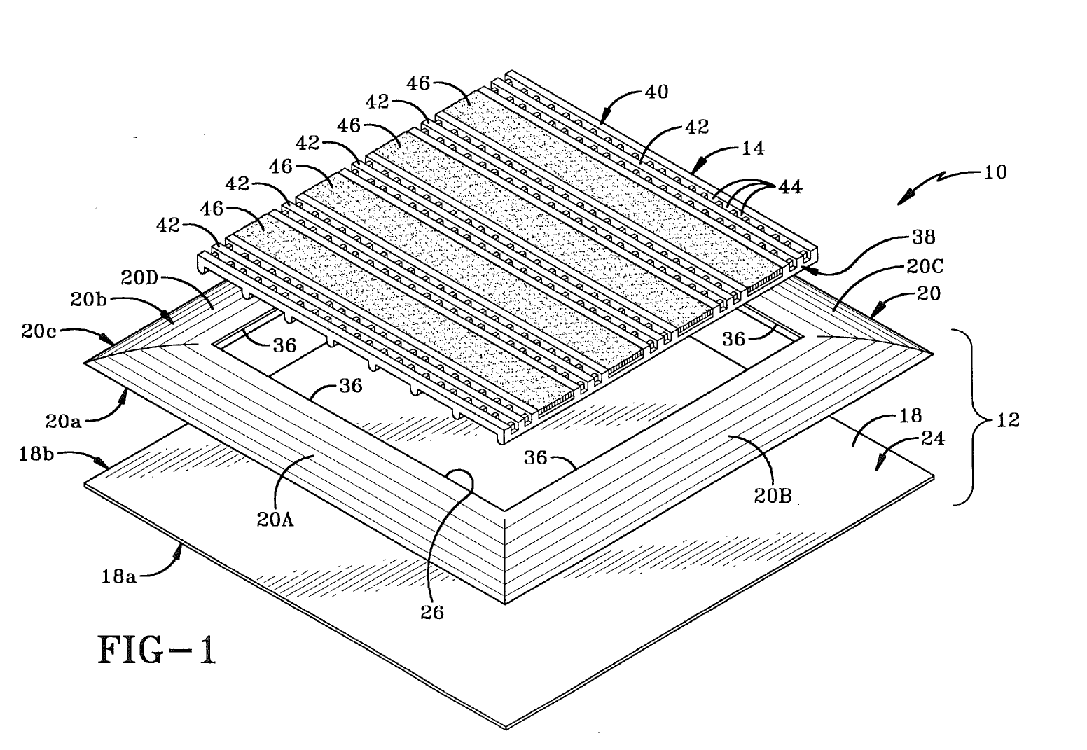

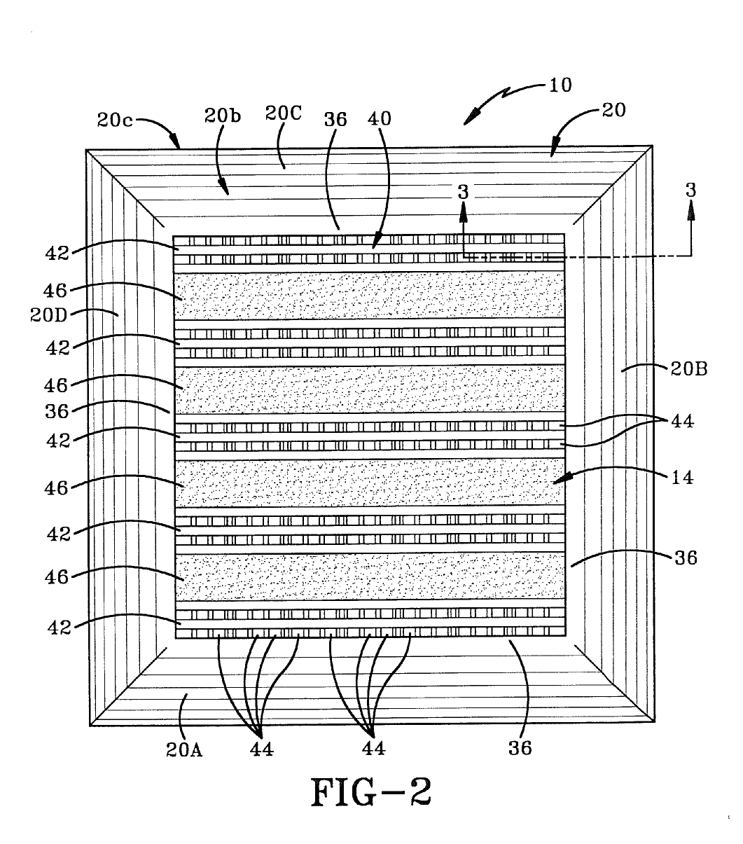

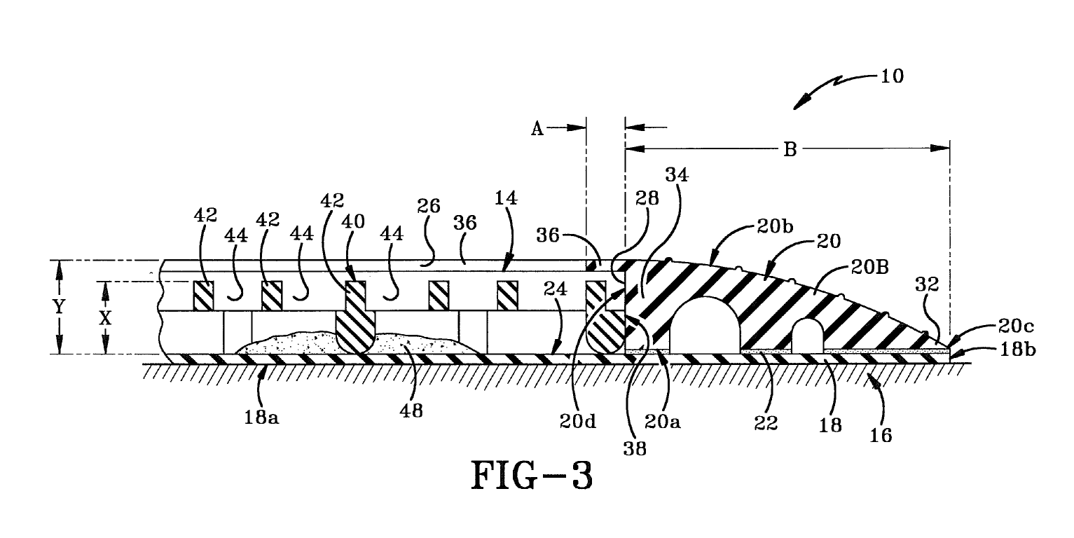

Referring to FIGS. 1-3, there is shown a mat assembly in accordance with the present invention and generally indicated at 10. Mat assembly 10 comprises a tray 12 and an insert 14 that is selectively receivable in tray 12. Mat assembly 10 is not fixed to any structure and therefore can be moved and positioned on a floor surface 16 (FIG. 3) as desired.

Tray 12 preferably is manufactured from a durable, impermeable and impervious material so that water is not absorbed into tray 12 and tray 12 does not allow liquid to pass through it. Tray 12 comprises a base 18 and a surround 20 that preferably are secured together by an adhesive layer 22. It will be understood by those skilled in the art that base 18 and surround 20 could alternatively be molded as an integrally formed unit without departing from the spirit of the present invention.

In mat assembly 10, base 18 preferably is a thin, flexible, planar layer made from any suitable plastic or rubber. The lower surface 18a of base 18 may also be textured in some manner to allow base 18 to grip floor surface 16.

Surround 20 comprises a plurality of individual molded members, such as 20A, 20B, 20C and 20D, that are glued together to form a peripheral wall having the desired shape for mat assembly 10. Each member 20A, 20B, 20C and 20D is molded from one of plastic and rubber and is shaped to form a ramp when viewed in cross-section. Surround 20 comprises a peripheral wall that has a bottom surface 20a, a top surface 20b, an outermost edge 20c and an innermost edge 20d. FIG. 3 shows that the peripheral wall of surround 20 is ramped and comprises a thinner portion 32 proximate outermost edge 20c and a thicker portion 34 proximate innermost edge 20d.

When connected together members 20A, 20B, 20C and 20D define a central aperture 26. that, when base 18 and surround 20 are secured together, forms an opening to a well 28. Well is complementary sized and shaped to received insert 14 therein.

A lip 36 projects inwardly from innermost edge 20d of surround 20 and into aperture 26. FIG. 3 shows that the length “A” of lip 36 is relatively small by comparison to the length “B” of the peripheral wall as measured between outermost edge 32 and innermost edge 34 of surround 20. In mat assembly 10, length “B” is between 1½ inches and 2½ inches and preferably is 2 inches, while length “A” is between ⅛ inch and ⅜ inch and preferably is ¼ inch. Consequently, when insert 14 is received in well 28, lip 36 projects only for a short distance over the peripheral edge 38 of insert 14. Furthermore, lip 36 is relatively inflexible and is substantially unable to be rotated upwardly away from upper surface 24 of base 18. Lip 36 serves to assist in retaining insert 14 in well 28, and also gives a more finished and aesthetically appealing appearance to mat assembly 10.

Insert 14 may be configured in a variety of designs but preferably is a flow-through type mat that includes a plurality of ribbed regions 42 interspersed with a plurality of holes 44. Insert 14 preferably is made from rubber and is fairly firm, being only slightly compressible but yet still being reasonably flexible. Insert 14 includes a plurality of fibrous regions 46 positioned at intervals between ribbed regions 42. The fibrous regions 46 may comprise strips of carpet that are flush with or extend partially above the ribbed regions 42. The alternate ribbed and fibrous regions 42, 46 remove liquid and particulate matter from the underside of shoes that engage upper surface 40 of insert 14. The liquid and particulate matter 48 drops through holes 44 and onto upper surface 24 of base 18 and accumulates in well 28. Insert 14 is of a slightly smaller height “X” (FIG. 3) than the depth “Y” of well 28, so that insert 14 is slightly recessed within well 28 and lip 36 extends for a small distance over the uppermost surface 40 of insert 14.

Mat assembly 10 is used in the following manner. During manufacture, insert 14 may be positioned on upper surface 24 of base 18 and surround 20 be applied thereover. Alternatively, base 18 and surround 20 may be assembled around insert 14 or may be connected together and insert 14 is then introduced into well 28 through aperture 26. Either way, when fully assembled insert 14 is seated within well 28 of tray 12 so that lip 36 extends for a short distance over peripheral edge 38 of insert 14. Mat assembly 10 is then placed on the floor surface 16 as desired. When shoes of people engage uppermost surface 40 then any liquid or particulate matter 48 on the underside thereof will be scraped off from the same and will drop into and accumulate within well 28. After a period of time, a sufficient quantity of liquid and particulate matter 48 will accumulate in well 28 to warrant cleaning of the assembly 10. Mat assembly 10 is then removed from the surface 16 and away from an entryway of the building or vehicle. Mat assembly 10 may be inverted so that the liquid and particulate material 48 can drop out of well 28. Alternatively, and preferably, insert 14 is removed, tray 12 is inverted and may be cleaned as by vacuuming or washing. Insert 14 is then repositioned in well 28. Mat assembly 10 can then be returned to the desired location on surface 16.

A second embodiment of a mat assembly in accordance with the present invention is shown in FIG. 4 and is generally indicated at 110. Mat assembly 110 is substantially identical to mat assembly 110 except that insert 114 is secured to upper surface 124 of base 118 by adhesive 150. Although not shown in this figure, adhesive may also be applied to the upper surface 140 of insert 114 in the region immediately beneath lip 136 and to the area of insert 114 that contacts surround 120. Mat assembly 110 is shown as comprising base 118 and surround 120 connected together by adhesive layer 122, but base 118 and surround may also be integrally formed.

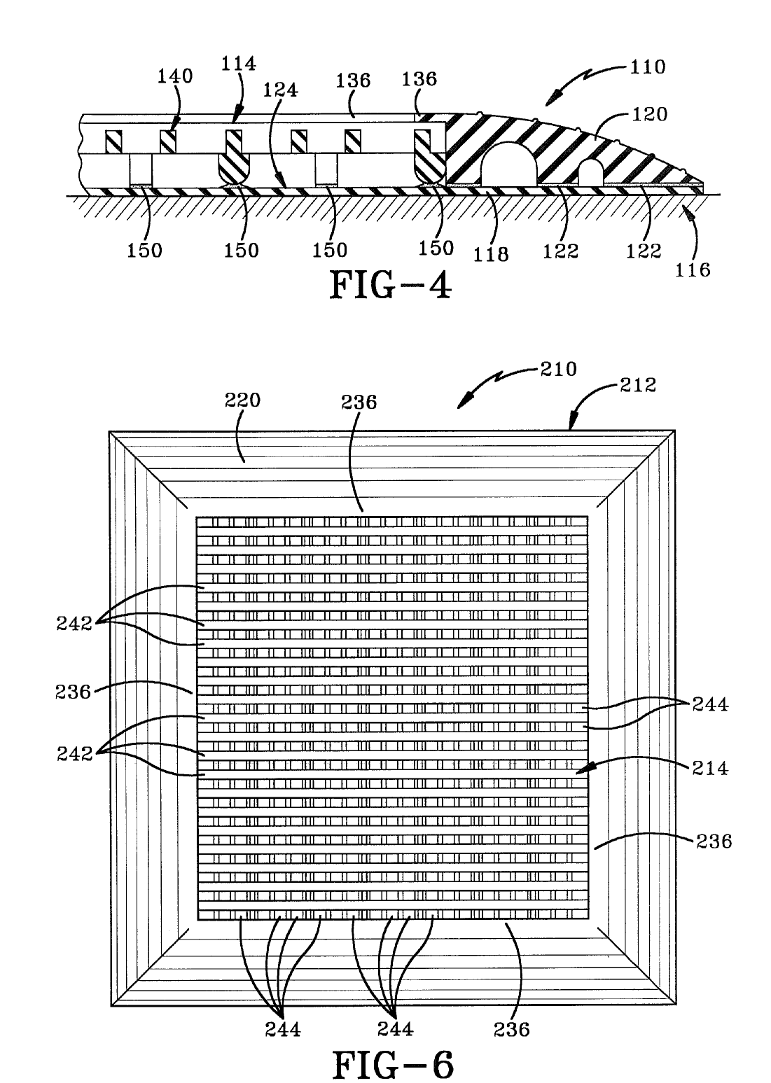

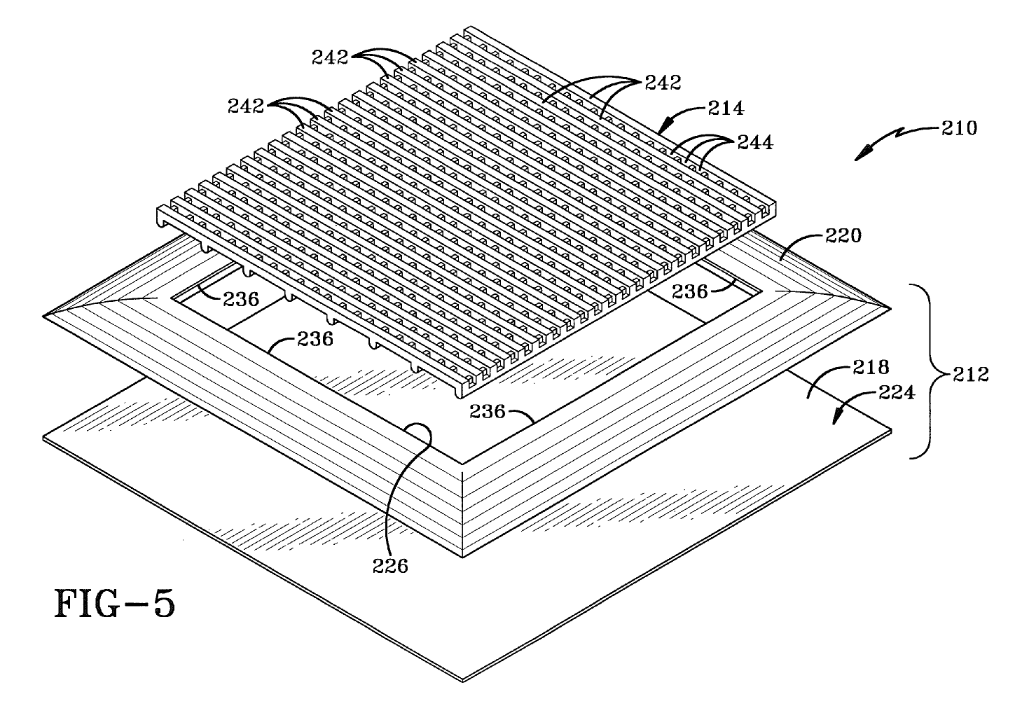

A third embodiment of a mat assembly in accordance with the present invention is shown in FIGS. 5 and 6, and is generally indicated at 210. Mat assembly 210 includes an insert 214 that is positionable in a tray 212. Tray 212 is manufactured in the same way as in the first and second embodiments of the invention and includes a base 218 and surround 220. In this instance, insert 214 comprises a rubber flow-through mat that only has a plurality of ribbed regions 242 and holes 244 and does not include any fibrous strips. The insert 214 is received in a well (not numbered) formed by aperture 226 in surround 220 and the upper surface 224 of base 218. The adhesive which secures base 218 and surround 220 may cover the entire upper surface 224 of base 218 and lock insert 214 in place as well.

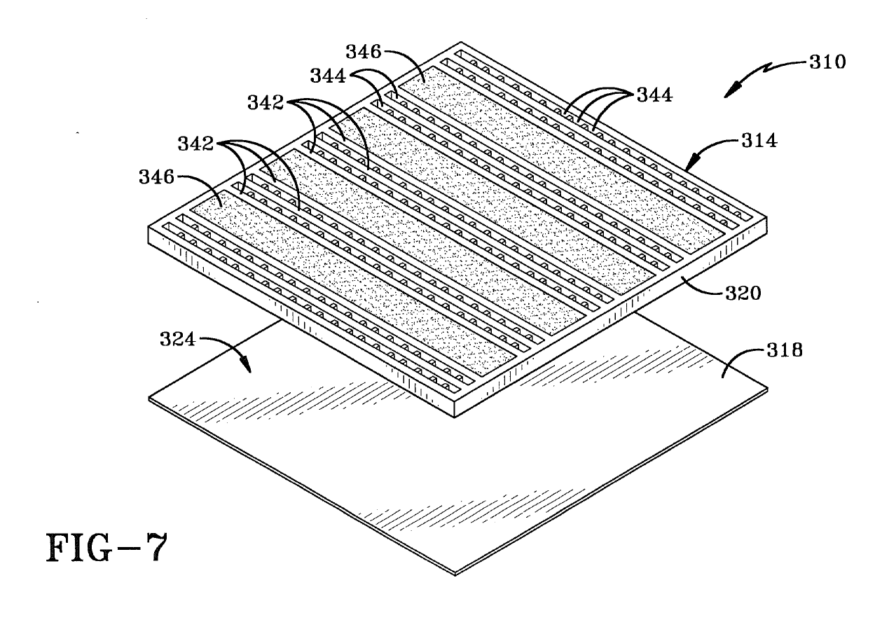

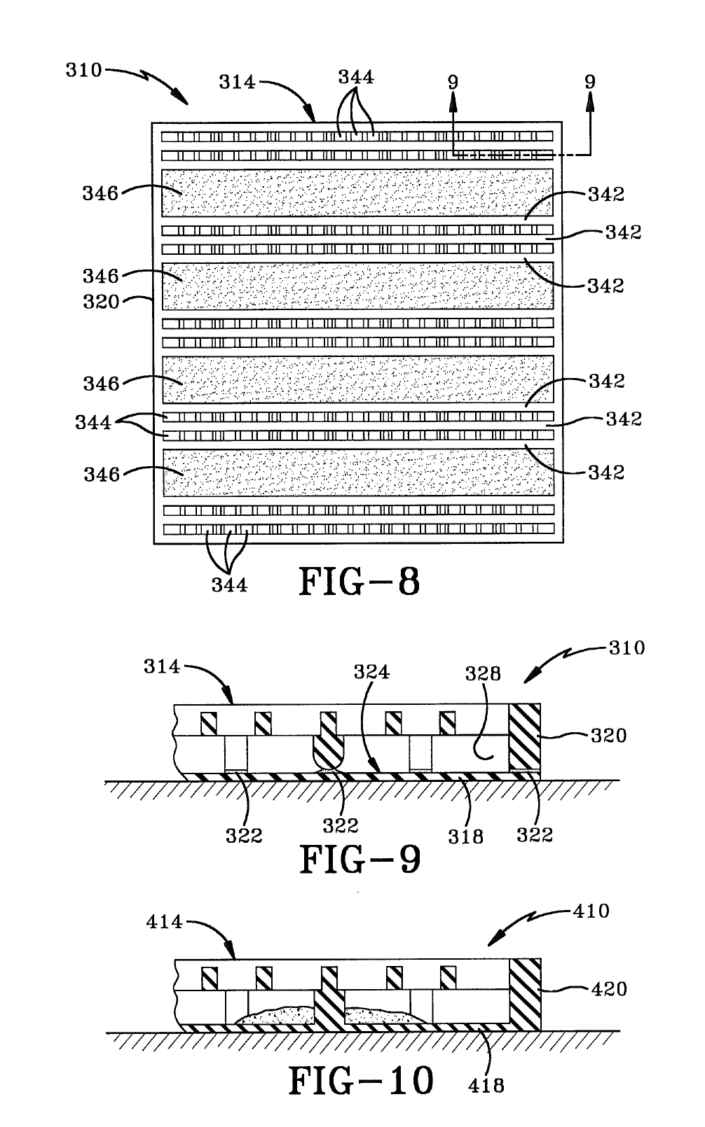

A fourth embodiment of a mat assembly in accordance with the present invention is shown in FIGS. 7-9, and is generally indicated at 310. Mat assembly 310 comprises a base 318 and a mat insert 314 and the surround 320 is formed as the peripheral outer wall of insert 314. Insert 314 is secured to base 318 by an adhesive layer 322. A well 328 is thus formed between surround 320 and upper surface 324 of base 318. Insert 314 may be of any suitable flow-through type format, such as the alternating ribbed regions 342 and fibrous regions 346 interspersed with holes 344. Liquid and particulate matter drops through holes 344 and into the well 328 where it accumulates.

A fifth embodiment of a mat assembly in accordance with the present invention is shown in FIG. 10, and is generally indicated at 410. Mat assembly 410 is substantially identical to mat assembly 310 except that surround 420 and base 418 are integrally formed instead of being adhesively connected together.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A self-contained floor mat assembly for selective placement on a floor surface; said mat assembly comprising:
a tray having an upper surface and a lower surface, said lower surface being adapted to rest on the floor surface;
a flow-through mat insert positionable on the upper surface of said tray, said insert including at least one hole that extends from an upper surface thereof through to a lower surface thereof; whereby said insert is adapted to allow liquid and particulate materials to drop through said hole and onto the upper surface of the tray.

2. The floor mat assembly as defined in claim 1, further comprising a surround which cooperates with the upper surface of said tray to form a well within which the liquid and particulate material accumulates and is substantially prevented from contacting the floor surface.

3. The floor mat assembly as defined in claim 2, wherein the tray includes a substantially planar, liquid impervious base; and the surround is connected to at least one of said base and the insert.

4. The floor mat assembly as defined in claim 3, wherein the surround is connected to the one of the base and the insert by an adhesive layer.

5. The floor mat assembly as defined in claim 3, wherein the surround is connected to the one of the base and the insert by being integrally formed therewith.

6. The floor mat assembly as defined in claim 2, wherein the surround comprises a ramped peripheral wall that circumscribes a central aperture; said peripheral wall being thinner proximate an outer edge that is remote from said aperture and being thicker proximate an inner edge that is adjacent said aperture.

7. The floor mat assembly as defined in claim 6, wherein the insert is complementary sized and shaped to be received within the aperture in the surround.

8. The floor mat assembly as defined in claim 7, wherein the surround further includes a lip that extends inwardly into the aperture from the inner edge of the peripheral wall.

9. The floor mat assembly as defined in claim 8, wherein the peripheral wall has a length from the inner edge to the outer edge thereof; and the lip has a length; and the length of the lip is substantially smaller than the length of the peripheral wall.

10. The floor mat assembly as defined in claim 9, wherein the length of the peripheral wall is between 1½ inches and 2½ inches long.

11. The floor mat assembly as defined in claim 10, wherein the peripheral wall is 2 inches long.

12. The floor mat assembly as defined in claim 9, wherein the lip is between ⅛ inch and ⅜ inch long.

13. The floor mat assembly as defined in claim 12, wherein the lip is ¼ inch long.

14. The floor mat assembly as defined in claim 8, wherein the lip projects over a portion of an outermost edge of the insert and is adhesively connected thereto.

15. The floor mat assembly as defined in claim 1, wherein the insert includes a plurality of ribs that are interspersed with a plurality of holes.

16. The floor mat assembly as defined in claim 15, wherein the ribs are manufactured from one of plastic and rubber.

17. The floor mat assembly as defined in claim 15, further comprising a plurality of areas of fibrous materials that are interspersed between the ribs.

18. The floor mat assembly as defined in claim 17, wherein the areas of fibrous materials comprise strips of carpeting.

19. The floor mat assembly as defined in claim 1, wherein the insert is adhesively secured to the upper surface of the tray.

20. The floor mat assembly as defined in claim 17, wherein the insert is adhesively secured to the upper surface of the tray.
